(19) United States
(12) Patent Application Publication
(10) Pub. No.: US 2010/0257453 A1
(43) Pub. Date: Oct. 7, 2010

(54) WATCHER PROPOSED PRESENCE STATES

(75) Inventor: Jack Jachner, Lexington, MA (US)

Correspondence Address: CAPITOL PATENT & TRADEMARK LAW FIRM, PLLC, P.O. BOX 1995, VIENNA, VA, 22183, US

(73) Assignee: Alcatel-Lucent USA Inc., Murray Hill, NJ (US)

(21) Appl. No.: 12/739,032

(22) PCT Filed: Nov. 13, 2007
(86) PCT No.: PCT/US07/84569

§ 371 Date: Apr. 21, 2010

(51) Int. Cl. G06F 15/16; G06F 3/048

(52) U.S. Cl. 715/738; 709/203; 715/810

(57) ABSTRACT

A presence system and method are described herein that enable a presence system based service (watcher) to submit a list of customized presence states to a user (presentity) who can then use their presence device to select one of the customized presence states which causes the presence system based service to invoke a specific service.

### CROSS REFERENCE TO RELATED APPLICATIONS

This application is related to the following U.S. patent applications:

1. U.S. patent application Ser. No. 11/282,144 filed on Nov. 18, 2005 and entitled “System and Method for Representation of User Preference and Policy in Contact List”. The contents of this document are incorporated by reference herein.

2. U.S. patent application Ser. No. 11/245,685 filed on Oct. 7, 2005 and entitled “Leveraging Presence Service System and Method for Distributed Web Service Delivery and Deployment”. The contents of this document are incorporated by reference herein.

3. U.S. patent application Ser. No. 11/463,928 filed on Aug. 11, 2006 and entitled “System and Method for Representation of Presentity Presence States for Contacts in a Contact List”. The contents of this document are incorporated by reference herein.

### TECHNICAL FIELD

The present invention relates to a presence system and method for enabling a presence system based service (watcher) to submit a list of customized presence states to a user (presentity) who can then select one of the customized presence states which causes the presence system based service to invoke a specific service.

### BACKGROUND

The following abbreviations are herewith defined, at least some of which are referred to in the following description associated with the prior art and the present invention.

| | |
|---|---|
| ALU | Alcatel-Lucent |
| GUI | Graphical User Interface |
| IM | Instant Messaging |
| IP | Internet Protocol |
| MSFT | Microsoft |
| PDA | Personal Digital Assistant |
| PSS | Presence System Based Service |
| SIP | Session Initiation Protocol |
| SIMPLE | SIP for Instant Messaging and Presence Leveraging |
| | Extensions |
| URL | Uniform Resource Locator |
| XML | Extensible Markup Language |

With today's widespread use of the Internet as a primary communication medium, data communication devices have been designed that are capable of communicating over packet-switched networks. For instance, telephones, pagers, personal digital assistant devices, cell phones, handheld computers, and fax machines can be accessed and controlled via the Internet. Communication over a packet-switched network using communication devices that traditionally communicate over a circuit-switched telecommunications network is generally known as network telephony, or IP telephony if there is an IP network involved.

Various types of user communication devices (e.g., a cell phone, laptop computer, desktop computer) can identify themselves to the packet-switched network using a suitable identifier (e.g., username@company.com). The packet-switched network can also support presence technology where “presence” refers to, for example, the availability, proximity, activity level, or operating state of a presentity, such as a user, object, communication device or anything that can have some kind of state. Presence can be loosely defined as knowledge about a presentity that is displayed to a watcher. Status information about the presentity and their communication devices is collected by various methods and devices for aggregation and processing or by a presence engine which transform the raw data into some useful form for the watcher.

The ability of users or objects to monitor each other's presence state is a feature offered in connection with many different applications that support network telephony. For example, IM applications have a buddy list or contact list feature, in which a user of the application can determine whether select users or objects are available for engaging in communication. In this case, the data retrieved and returned to the contact list, e.g., “John OFFLINE” or “Susan ONLINE”, is referred to as “presence state,” and is generally maintained by a presence server, which is often a dedicated server in the packet-switched network. Typically, the presence server supports network telephony protocols such as SIP/SIMPLE. Users can register their communication devices with the presence server to have their presence maintained and to allow various programs on the packet-switched network to facilitate network telephony services. In particular, a first device user wishing to detect the presence state of a second device user does so by “subscribing” with the presence server, such as via a SIP SUBSCRIBE message. The presence server intermediates between the first device user (also known as a “watcher” or “subscriber”) and the second device user (also known as a “presentity”) to facilitate the communication of the presentity's presence state to the watcher.

The current presence systems (e.g., MSFT Live and Office Communicator, ALU My Teamwork) available on the market today use a defined list of user presence states including “online”, “busy”, “be right back”, “away”, “on the phone”, “out to lunch” and “appear offline”. As such, the second user (presentity) can interact with their device and set their presence state to be “out to lunch” and as a result the first user (watcher) is notified that the second user (presentity) is not in their office but instead is currently out to lunch. FIG. 1 (PRIOR ART) is a block diagram of a traditional device/GUI 100 displaying the defined presence states 102 which can be selected by the second user (presentity). In addition, the current presence systems per the current presence standards optionally enable the presentity to compose their own presence state (e.g., “out to lunch to Arby's be back at 2 PM”.

The defined list of presence states 102 and the presentity's customized presence states available in the current presence systems and supported by the current presence standards are not sufficient to take into account the wide range of potential implementations of PSSs (or web services). The PSSs are watchers of the presentity and they can provide various services like, for example, functioning as a contact center for product support (Dell® Support Service) or function as a stock trading service (Fidelity® Financial Service). In these applications, the presence states should be adapted to specific PSS services so that the presentity can select a presence state that is specifically meaningful, relevant and understood by the specific PSS so they can deliver a specific service to the presentity. For example, it would be desirable if the contact center PSS could propose and respond to a specific user presence state “be right back, keep my place in the queue”, or a stock quote PSS service could propose and respond to specific user presence states “want to buy”, and “want to sell”, etc. . . . Unfortunately, this is not currently possible with the state-of-the-art technology.

Basically, the predefined list of presence states 102 is not suitable for PSS applications and the presentity composed input of custom presence states is not suitable as well because it is to complex and unreliable for the PSS services to understand and respond to all of the different ways that a presentity can describe their presence state in customized free-form text. Thus, there is a need to have customized user presence states (e.g., “be right back, keep my place in the queue”, “want to buy”, “want to sell”) which describe user states that are specifically meaningful and relevant to PSSs that function as watchers of the user's presence states. This need and other needs are satisfied by the presence system and method of the present invention.

### SUMMARY

In one aspect, the present invention provides a method for enabling a PSS to customize presence states that can be used by a presentity. The method comprising the steps of: (a) communicating a list of customized presence states to a device used by the presentity; (b) receiving an indication that one of the customized presence states had been selected by the presentity; and (c) invoking a service in response to the selected customized presence state.

In another aspect, the present invention provides a method for enabling a presentity to receive and utilize customized presence states. The method comprising the steps of: (a) using a device to receive a list of customized presence states created by a PSS; and (b) selecting one of the customized presence states to cause the PSS to invoke a specific service that is related to the selected customized presence state.

In yet another aspect, the present invention provides a device which has a graphical user interface and a processor which accesses instructions from a memory and then processes the instructions to enable the following operations: (a) receive a list of customized presence states created by a PSS; (b) display the list of customized presence states on the graphical user interface; and (c) enable a presentity to select one of the customized presence states to cause the PSS to invoke a specific service in response to the selected customized presence state.

In still yet another aspect, the present invention provides a system including a PSS server having a processor which accesses instructions from a memory and then processes the instructions to enable the following operations: (a) create a list of customized presence states; and (b) communicate the list of customized presence states. In addition, the system includes a device which has a graphical user interface and a processor which accesses instructions from a memory and then processes the instructions to enable the following operations: (a) receive the list of customized presence states communicated by the PSS server; (b) display the list of customized presence states on the graphical user interface; and (c) enable a presentity to select one of the customized presence states to cause the PSS server to invoke a specific service in response to the selected customized presence state.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 (PRIOR ART) is a diagram of a device/GUI displaying the defined presence states which are supported by the current presence standards and used by traditional presence systems;

FIG. 2 is a block diagram illustrating the basic components of a presence system in accordance with the present invention;

FIG. 3 is a flowchart illustrating the basic steps of a preferred method for enabling a presence system based service (watcher) to customize presence states that can be used by a presentity (user) in accordance with the present invention;

FIGS. 4-6 are various diagrams associated with an exemplary scenario which are used to help explain in greater detail how the preferred method of FIG. 3 can be implemented in accordance with one embodiment of the present invention;

FIGS. 7-8 are various diagrams associated with another exemplary scenario which are used to help explain in greater detail how the preferred method of FIG. 3 can be implemented in accordance with another embodiment of the present invention; and

FIGS. 9-10 are diagrams of a rich presence device/GUI displaying different customized presence states which can be monitored by selected PSSs (watchers) in accordance with an embodiment of the present invention.

### DETAILED DESCRIPTION

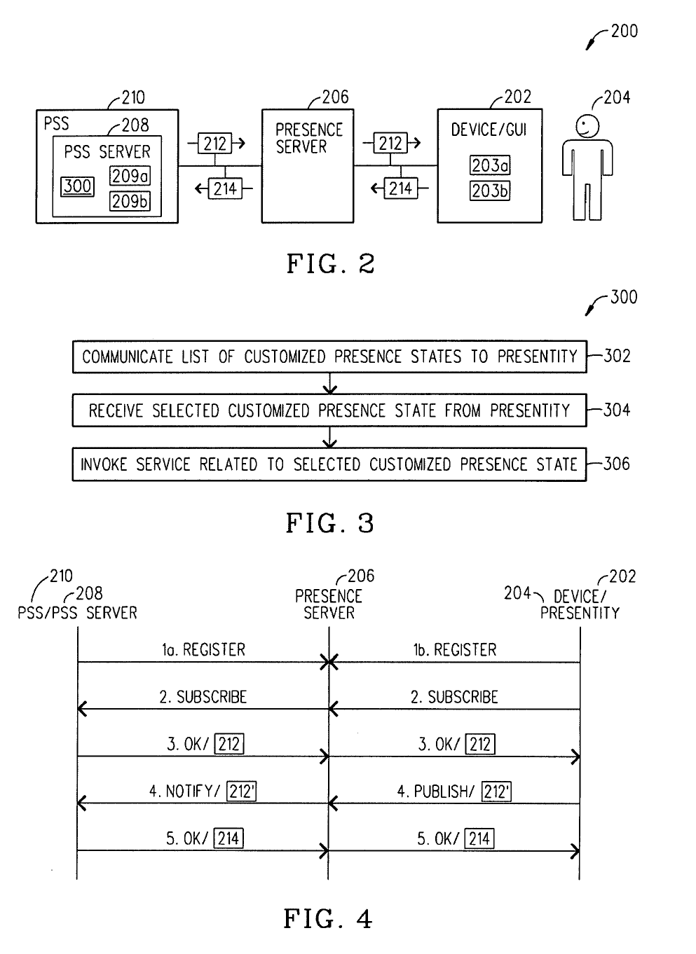

Referring to FIG. 2, there is shown a block diagram of a presence system 200 that is configured in accordance with the present invention. The presence system 200 includes a device/GUI 202 (which is used by a presentity 204), a presence server 206, and a PSS server 208 (which is used by a PSS 210 and implements method 300 as discussed below). The device/GUI 202 could be anyone of a wide variety of devices including, for example, a desktop computer 202, a laptop computer 202, a PDA 202, a mobile phone 202. The presence server 206 (and if used an optional presence engine) can service multiple presentities 204 and multiple PSSs 210 at the same time but for clarity only one PSS 210 and only one presentity 204 have been discussed herein as being serviced by the presence server 206.

Referring to FIG. 3, there is shown a flowchart of a method 300 for enabling the PSS 210 (watcher 210) to customize presence states which can be used by a presentity 204 (user 204) in accordance with the present invention. Basically at step 302, the PSS 210 and in particular the PSS server 208 communicates a list of customized presence states 212 through the presence server 206 to the device/GUI 202. At step 304, the PSS 210 and in particular the PSS server 208 receives an indication 214 from the presence server 206 that one of the customized presence states 212 had been selected by the presentity 204. At step 306, the PSS 210 and in particular the PSS server 208 invokes a service that is specifically related to the selected customized presence state 212 (note: if desired the PSS server 208 can communicate directly with the device/GUI 202 and vice versa without the presence server 206). Several signal flow diagrams are discussed below along with some exemplary scenarios to help describe in more detail how the PSS 210 can implement the method 300 in accordance with the present invention.

Referring to FIG. 4, there is a signal flow diagram illustrating the step-by-step process used so the PSS 210 (watcher 210) can create customized presence states 212 which are sent to and then used by a presentity 204 in accordance with one embodiment of the present invention. The steps are as follows:

1a-1b. The PSS 210 (in particular the PSS server 208) and the presentity 204 (in particular the device/GUI 202) both register with the presence server 206. A basic function of the presence server 206 is to enable the presentity 204 to locate the PSS 210.

2. The presentity 204 subscribes with the presence server 206 to have a relationship with the specific PSS 210. In this example, the presentity 204 (in particular the device/GUI 202) accomplishes this by sending a SUBSCRIBE message to the presence server 206 which is then forwarded to the PSS 210 (in particular the PSS server 208).

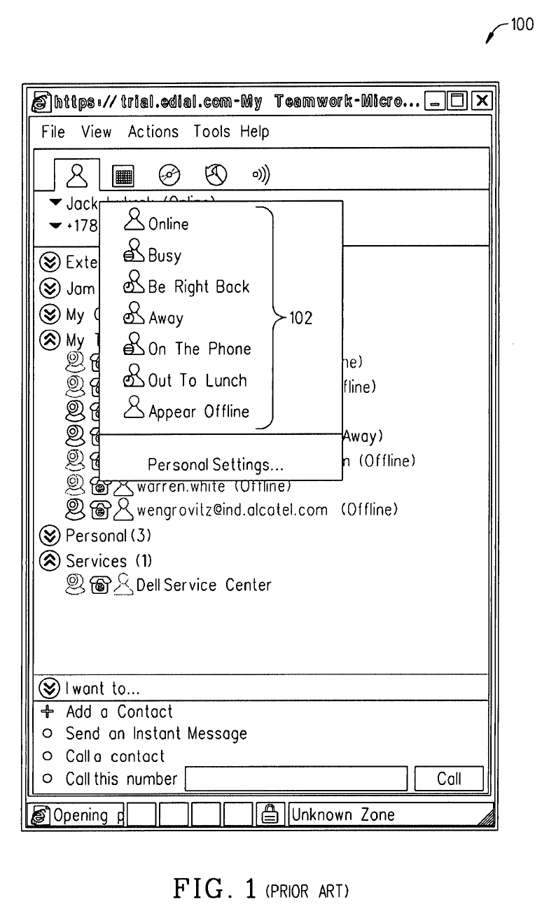

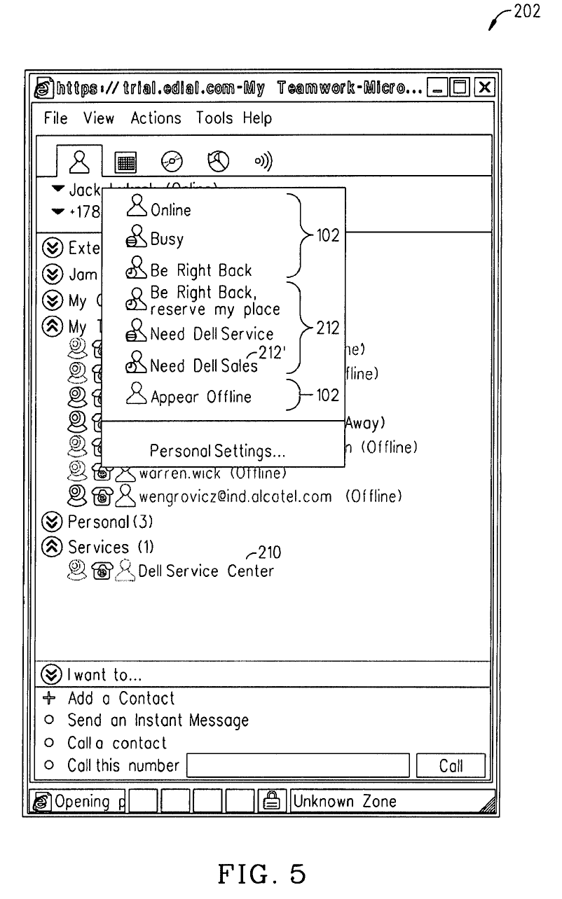

3. Assuming the PSS 210 accepts the SUBSCRIBE message, the PSS 210 (in particular the PSS server 208) sends an OK message which contains the customized presence states 212 to the presence server 206 which then forwards the OK message and customized presence states 212 to the presentity 204 (in particular the device/GUI 202) (see step 302 in FIG. 3). Alternatively, the PSS 210 (in particular the PSS server 208) can bypass the presence server 206 and send the OK message with the customized presence states 212 directly to the presentity 204 (in particular the device/GUI 202) (see step 302 in FIG. 3). FIG. 5 is a diagram of a device/GUI 202 displaying exemplary customized presence states 212 which could be sent from a specific PSS 210 (e.g., Dell® Support Service 210) to the presentity 204 in accordance with the present invention (compare to FIG. 1).

4. The presentity 204 interacts with the device/GUI 202 and selects one of the customized presence states 212′ such as for example “Need Dell Sales” and this selection is sent in a PUBLISH message to the presence server 206 and fowarded in a NOTIFY message to the PSS 210 (in particular the PSS server 208).

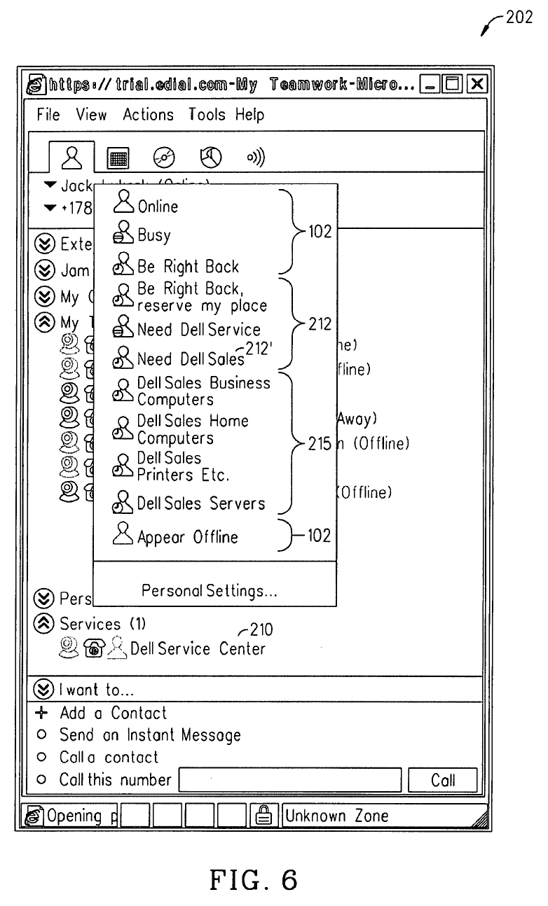

5. The PSS 210 (in particular the PSS server 208) upon receiving the NOTIFY message with the selected customized presence state 212′ (e.g., “Need Dell Sales”) can then invoke a specific service such as for example replying with an OK message (or another NOTIFY message) that contains additional customized presence states 215 like, for example, “Dell Sales Business Computers?”, “Dell Sales Home Computers?”, “Dell Sales Printers etc.?” and “Dell Sales Servers” (see steps 304 and 306 in FIG. 3) (note: the presentity 204 can select one of these new customized states 215 and then the PSS 210 would invoke another specific service like, for example, call the presentity 204 or email them relevant information). FIG. 6 is a diagram of a device/GUI 202 displaying exemplary customized presence states 215 which could be sent from the specific PSS 210 (e.g., Dell® Support Service 210) to the presentity 204 in accordance with the present invention (compare to FIG. 5).

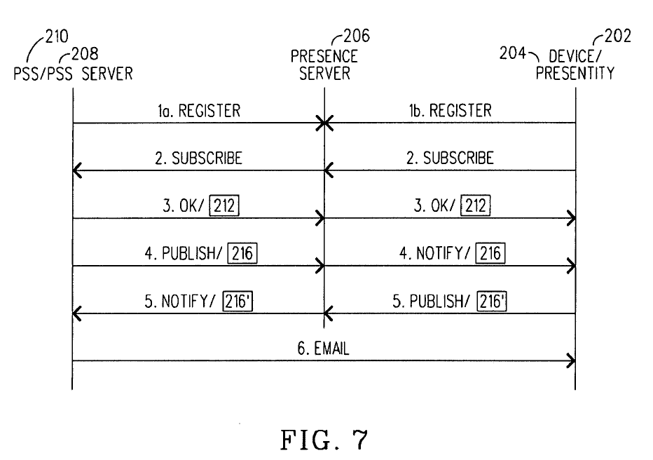

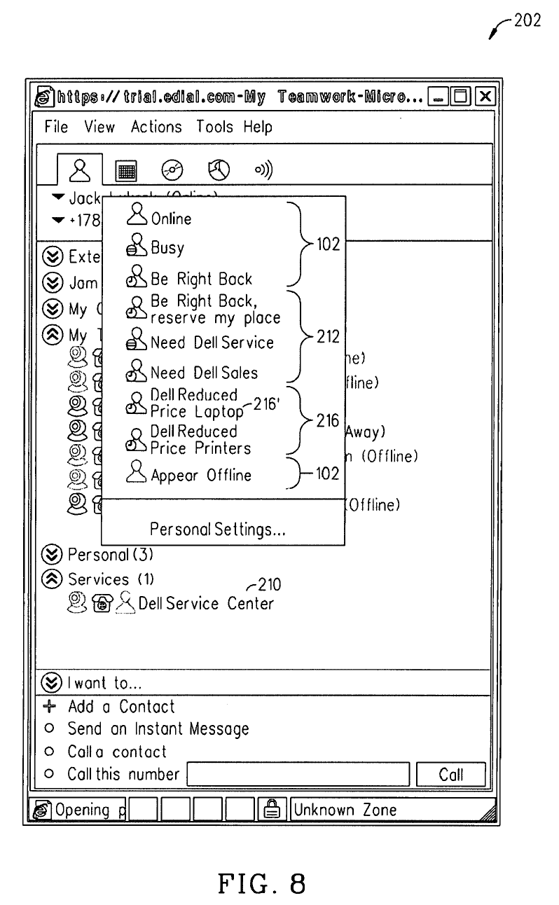

Note 1: The user's device/GUI 202 includes a processor 203a which accesses instructions from a memory 203b and processes the instructions to enable the various operations associated with the present invention including: (a) receiving a list of customized presence states 212 created by the PSS 210; (b) displaying the list of customized presence states 212 on the graphical user interface; and (c) enabling the presentity 204 to select one of the customized presence states 212 to cause the PSS 210 to invoke a specific service in response the selected customized presence state 212′.
Note 2: The PSS server 208 includes a processor 209a which accesses instructions from a memory 209b and processes the instructions to enable the various operations associated with the present invention including: (a) communicating a list of customized presence states 212 to the device/GUI 202 used by the presentity 204; (b) receiving an indication 214 that one of the customized presence states 212 had been selected by the presentity 204; and (c) invoking a service in response to the selected customized presence state 212′.
Note 3: If desired the PSS 210 and presentity 204 can communicate directly with one another without the presence server 206. Assuming the presentity 204 is aware of the PSS 210, then the presentity 204 can send their SUBSCRIBE message directly to the PSS 210 which enables the PSS 210 to send the customized presence states 212 directly to the presentity 204 and also enables the PSS 210 to directly monitor the presence of the presentity 204 (note: this option is also possible with the scenario discussed next with respect to FIGS. 7-8).
Note 4: If desired the presentity 204 can be another PSS 210 such that one PSS 210 is a watcher of another PSS 210 which is a presentity 204. For instance, the watcher PSS 210 can be a mutual fund and the presentity PSS 210 can be a computerized agent that buys and sells securities for the mutual fund (note: this option is also possible with the scenario discussed next with respect to FIGS. 7-8).

Referring to FIG. 7, there is a signal flow diagram illustrating the step-by-step process used so the PSS 210 (watcher 210) can create customized presence states 212 which are sent to and then used by a presentity 204 in accordance with another embodiment of the present invention. The steps are as follows:

1a-1b. The PSS 210 (in particular the PSS server 208) and the presentity 204 (in particular the device/GUI 202) both register with the presence server 206. A basic function of the presence server 206 is to enable the presentity 204 to locate the PSS 210.

2. The presentity 204 subscribes with the presence server 206 to have a relationship with the specific PSS 210. In this example, the presentity 204 (in particular the device/GUI 202) accomplishes this by sending a SUBSCRIBE message to the presence server 206 which is then forwarded to the PSS 210 (in particular the PSS server 208).

3. Assuming the PSS 210 accepts the SUBSCRIBE message, the PSS 210 (in particular the PSS server 208) sends an OK message which contains the customized presence states 212 to the presence server 206 which then forwards the OK message and customized presence states 212 to the presentity 204 (in particular the device/GUI 202) (see step 302 in FIG. 3 and the exemplary display shown in FIG. 5). Alternatively, the PSS 210 (in particular the PSS server 208) can bypass the presence server 206 and send the OK message with the customized presence states 212 directly to the presentity 204 (in particular the device/GUI 202).

4. After a certain amount of time, the PSS 210 (in particular the PSS server 208) sends a PUBLISH message which contains some additional customized presence states 216 to the presence server 206 which then sends a NOTIFY message and the additional customized presence states 216 to the presentity 204 (in particular the device/GUI 202). Alternatively, the PSS 210 (in particular the PSS server 208) can bypass the presence server 206 and send a NOTIFY message with the additional customized presence states 216 directly to the presentity 204 (in particular the device/GUI 202) (note: the PSS 210 can send additional customized presence states whenever the circumstances warrant such as when a monitored stock has dropped below a predetermined price). FIG. 8 is a diagram of a device/GUI 202 displaying exemplary additional customized presence states 216 (e.g., “Dell Reduced Price Laptop”, “Dell Reduced Price Printers”) which could be sent from the specific PSS 210 (e.g., Dell® Support Service 210) to the presentity 204 in accordance with the present invention (compare to FIG. 5).

5. The presentity 204 interacts with the device/GUI 202 and selects one of the additional customized presence states 216′ such as for example “Dell Reduced Price Laptop” and this selection is sent in a PUBLISH message to the presence server 206 and then forwarded in a NOTIFY message to the PSS 210 (in particular the PSS server 208).

6. The PSS 210 (in particular the PSS server 208) upon receiving the NOTIFY message with the selected customized presence state 216′ such as “Dell Reduced Price Laptop” can then invoke a specific service such as for example calling the presentity 204 or sending an email to the presentity 204 with a link to a website having a listing of laptops that are currently on sale (see steps 304 and 306 in FIG. 3).

A potential drawback of these scenarios is that when the presentity 204 selects one of the customized presence states 212′ and 216′ then all of the watchers and not just the corresponding PSS 210 are going to see this particular selected presence state 212′ and 216′. For instance, a watcher that is a co-worker in addition to the PSS 210 would see that the presentity 204 has a presence state 212′ (e.g., “Need Dell Sales”). This publication of the selected customized presence state 212′ (e.g., “Need Dell Sales”) may not be desirable since many of the watchers like the co-worker may not recognize or even desire to see the selected customized presence state 212′ (e.g., “Need Dell Sales”).

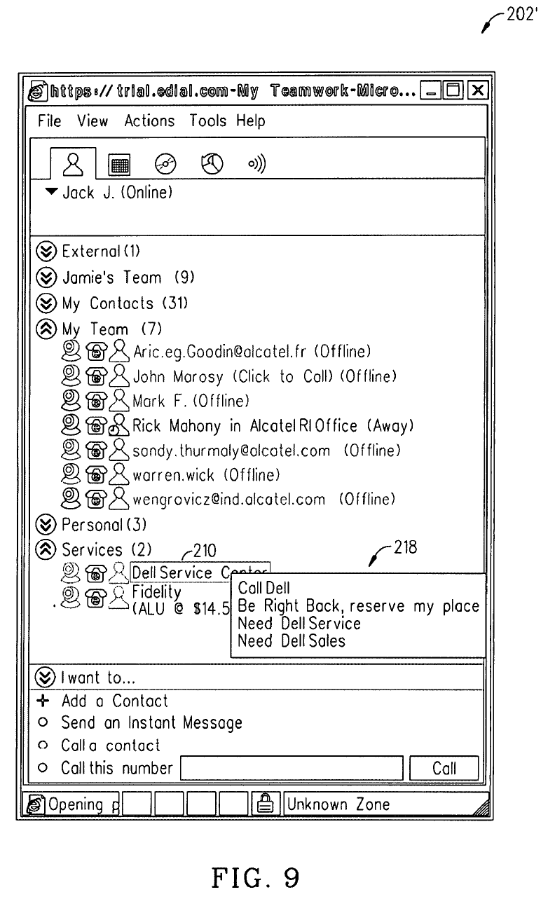

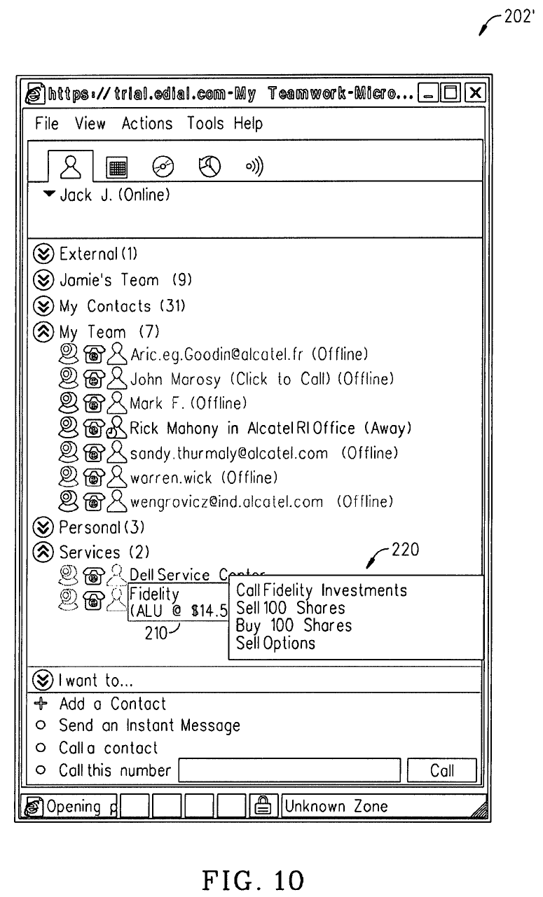

However, the presentity 204 can address this drawback by using a rich presence device/GUI 202 (or rich intelligent presence device/GUI 202) which would enable them to select which presence states including the pre-defined presence states 102 and the customized presence states 212, 215 and 216 can be viewed by a specific watcher or group of watchers. FIG. 9 is a diagram of a rich presence device/GUI 202′ where the presentity 204 has clicked on “Dell Service Center” (a specific PSS 210) which results in the display of a pull-down list of customized presence states 218 (e.g., Dell specific presence states 218) which are received from and can only be monitored by the “Dell Service Center” 210. Whereas, FIG. 10 is a diagram of a rich presence device/GUI 202′ where the presentity 204 has clicked on “Fidelity (ALU @ $14.50)” (a specific PSS 210 that shows the current value of ALU stock to be $14.50) which results in the display of a pull-down list of customized presence states 220 (e.g., Fidelity specific presence states 220 associated with various possible stock transactions related to ALU stock) which are received from and can only be monitored by the “Fidelity Investment Center” 210b.

From the foregoing, it can be appreciated that the present invention enables a PSS 210 to communicate to its subscribers 204 (users 204) a list of customized user presence states 212 to which the PSS 210 is responsive, and to have the users presence devices 202 receive and display that list so that the users 204 may select from that list a presence state 212 that is appropriate to the user's desire to invoke an associated service by the PSS 210. Basically, the present invention effectively extends the existing presence model such that users 204 (presentities 204) can now select a customized presence state 212 from a list of customized presence states 212 that was sent to them from the watchers 210 where the selected presence state 212 is then published to the presence server 206 and/or notified to the presence watchers 210. The present invention has the following features, capabilities and advantages:

1. The presence protocols would be extended so that a watcher 210 (PSS 210) may propose to presentities 204 to which it is subscribed a list of customized presence states 212 to which the watcher 210 is responsive for invoking a specific service. For example, this can be accomplished by adding an extension to the SUBSCRIBE message exchange in the SIMPLE protocol (note: the extension to the SUBSCRIBE message can be either a standardized extension or a proprietary extension).

2. The user's presence device/GUI 202 would be configured to allow the user 204 to see and select from an extended list of customized presence states 212.

3. If the user 204 selects their presence state to correspond to one of the entries on the list of customized presence states 212 that was provided by the PSS 210, then the PSS 210 would invoke a specific service corresponding to the selected presence state 212.

4. If desired, the user 204 can use a rich presence device/GUI 202 to select different customized presence states 212 that can be seen by different watchers 210 (e.g., different PSS services 210). For instance, the user 204 can use their rich presence device/GUI 202 to select and enable one watcher 210 (or group of watchers 210) to monitor a first set of customized presence states 218 and then select and enable another watcher 210 (or another group of watchers 210) to monitor another set of customized presence states 220.

5. The present invention is desirable in that the deployment of the PSSs 210 and their customized presence states 212 can be made independent of the evolution of the presence server 206, the device/GUI 202 and the presence protocols. Basically, each PSS 210 would be able to have a standard device/GUI 202 display customized user presence states 212 which invoke the services offered by the PSS 210.

6. The expected deployment of PSS services over the rapidly emerging presence system infrastructure and presence device deployments is likely to mirror the deployment of web services on the intranet. Hence, the present invention is a necessary enabler to help with the rapid and varied deployments of the PSS services 210.

For a more detailed discussion about the basics of the presence technology, reference is made to the following documents:
Jack Jachner et al. “Rich Presence: A New User Communications Experience” Technology White Paper, 8 pages, copyrighted 1st quarter 2005.
J. Rosenberg, “A Data Model for presence”, draft-ietf-simple-data-model-05 (work in progress), Sep. 22, 2005.
J. Rosenberg “A presence Event package for the Session initiation protocol (SIP)”, RFC 3856, August 2004.
H. Shulzerine et al. “RPID: Rich Presence Extensions to the presence Information Data Format (PIDF)”, draft-ietf-simple-rpid-08, (work in progress), Jul. 16, 2005.
Rosenberg, J. “Presence Authorization Rules”, draft-ietf-simple-presence-rules-03 (work in progress), Jul. 20, 2005.

The contents of these documents are hereby incorporated by reference herein.

Although several embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the spirit of the invention as set forth and defined by the following claims.

1. A method for enabling a presence system based service to customize presence states that can be used by a presentity, said method comprising the steps of:
communicating a list of customized presence states to a device used by the presentity;
receiving an indication that one of the customized presence states had been selected by the presentity; and
invoking a service in response to the selected customized presence state.

2. The method of claim 1, wherein said communicating step is performed during a subscription process that is controlled by a presence server located between the presence system based service and the presentity.

3. The method of claim 1, wherein said communicating step is performed during a notification process directly between the presence system based service and the presentity.

4. The method of claim 1, wherein said communicating step further includes a step of forwarding the list of customized presence states through a presence server to the device used by the presentity.

5. The method of claim 1, wherein said communicating step further includes a step of forwarding the list of customized presence states directly to the device used by the presentity.

6. The method of claim 1, wherein after receiving the indication that one of the customized presence states had been selected by the presentity then performing a step of communicating another list of customized presence states to the device used by the presentity.

7. The method of claim 1, wherein said presentity controls the device to ensure that the presence system based service and if desired at least one selected watcher are the only ones which are able to receive the indication that the presentity selected one of the customized presence states.

8. The method of claim 1, wherein said presentity is another presence system based service.

9. A method for enabling a presentity to receive and utilize customized presence states, said method comprising the steps of:
using a device to receive a list of customized presence states created by a presence system based service; and
selecting one of the customized presence states to cause the presence system based service to invoke a specific service in response the selected customized presence state.

10. The method of claim 9, wherein said device receives the list of customized presence states from a presence server which had received the list of customized presence states from the presence system based service.

11. The method of claim 9, wherein said device receives the list of customized presence states directly from the presence system based service.

12. The method of claim 9, wherein said device receives another list of customized presence states when the presence system based service invokes the specific service which is related to the selected customized presence state.

13. The method of claim 9, further comprising a step of enabling the presentity to use the device to ensure that the presence system based service and if desired at least one selected watcher are the only ones which are able to receive an indication that the presentity selected one of the customized presence states.

14. A device, comprising:
a graphical user interface;
a processor;
a memory; and
instructions which are accessible from said memory and processable by said processor to enable the following operations:
receive a list of customized presence states created by a presence system based service;
display the list of customized presence states on the graphical user interface; and
enable a presentity to select one of the customized presence states which causes the presence system based service to invoke a specific service in response to the selected customized presence state.

15. The device of claim 14, wherein said processor enables the reception and display of another list of customized presence states when the presence system based service invokes the specific service in response to the selected customized presence state.

16. The device of claim 14, wherein said processor enables the presentity to ensure that the presence system based service and if desired at least one selected watcher are the only ones which are able to receive an indication that the presentity selected one of the customized presence states.

17. A system, comprising:
a presence system based service server including:
a processor;
a memory; and
instructions which are accessible from said memory and processable by said processor to enable the following operations:
create a list of customized presence states; and
communicate the list of customized presence states; and
a device including:
a graphical user interface;
a processor;
a memory; and
instructions which are accessible from said memory and processable by said processor to enable the following operations:
receive the list of customized presence states communicated by the presence system based service server;
display the list of customized presence states on the graphical user interface; and
enable a presentity to select one of the customized presence states which causes the presence system based service server to invoke a specific service in response to the selected customized presence state.

18. The system of claim 17, further comprising a presence server which enables the communications between the device and the presence system based service server.

19. The system of claim 17, wherein said device enables the reception and display of a second list of customized presence states when the presence system based service server invokes the specific service in response to the selected customized presence state.

20. The system of claim 17, wherein said device enables the presentity to ensure that the presence system based service server and if desired at least one selected watcher are the only ones which are able to receive an indication that the presentity selected one of the customized presence states.
